(19) United States
(12) Patent Application Publication
(10) Pub. No.: US 2010/0139078 A1
(43) Pub. Date: Jun. 10, 2010

(54) METHOD FOR FORMING A MULTIPLE MATERIAL FAIRWAY-TYPE GOLF CLUB HEAD

(75) Inventors: PATRICK DAWSON, SAN DIEGO, CA (US); BRADLEY C. RICE, CARLSBAD, CA (US)

Correspondence Address: CALLAWAY GOLF C0MPANY, 2180 RUTHERFORD ROAD, CARLSBAD, CA, 92008-7328, US

(73) Assignee: CALLAWAY GOLF COMPANY, CARLSBAD, CA (US)

(21) Appl. No.: 12/621,370

(22) Filed: Nov. 18, 2009

Related U.S. Application Data
(60) Provisional application No. 61/119,818, filed on Dec. 4, 2008.

(51) Int. Cl. B23P 17/00; B22D 23/00

(52) U.S. Cl. 29/527.5

(57) ABSTRACT

A method for forming a fairway-type golf club head having a composite crown is disclosed herein. The method includes casting a subassembly, compression molding a crown component, and bonding the crown component to the subassembly.

### CROSS REFERENCES TO RELATED APPLICATIONS

The present application claims priority to U.S. Provisional Patent Application No. 61/119,818, filed on Dec. 4, 2008.

### STATEMENT REGARDING FEDERALLY SPONSORED RESEARCH OR DEVELOPMENT

Not Applicable

### BACKGROUND OF THE INVENTION

1. Field of the Invention

The present invention relates to a method for forming a multiple material fairway-type golf club head.

2. Description of the Related Art

The prior art discloses several methods for forming a golf club head.

One method is full casting which involves casting the entire golf club head, usually with a face pull tool. Duquette et al., U.S. Pat. No. 6,978,976 for a Magnetized Core With Pneumatic Release System For Creating A Wax Mold For A Golf Club Head describes certain aspects of the full casting method. Then a face insert is welded to the golf club head.

Another method is using a full casting method, using a face pull tool and then cutting a crown opening. A graphite crown is then bonded to cover the opening thereby forming a multiple material golf club head.

Yet another method is forming an entire golf club head from multiple pieces. In this method, several pieces (crown, sole, face and hosel) are welded together to form a precursor golf club head. Then, an opening is cut in the crown creating an opening. A graphite crown is then bonded to cover the opening thereby forming a multiple material golf club head.

Yet another method is a high performance multiple piece golf club head. This forming method involves making a multiple piece golf club head. The crown material needs to be of high quality expensive titanium so prior to welding the crown component to the sole component, the crown is chemically milled to the limits of drop tower durability. The chemical milling process is necessary to render the crown component to be competitive with graphite strength to weight ratio.

The current construction includes tacking a face component to sole (called face subassembly). Manually trim and tack crown to face subassembly. Fully weld face, crown, and sole (21 inches of weld). Grind weld and polish head.

Each of these prior art methods have drawbacks. Both multiple piece graphite crown and full casting require the manufacturer to produce a complete golf club head. The crown opening is then cut and replaced with a graphite crown. This is obviously wasteful because of the need to fabricate an entire golf club head and then removing a portion. The high performance multiple piece golf club head remedies this wastefulness by utilizing an expensive titanium material and which adds more cost to render the crown component weight competitive to graphite crowns.

### BRIEF SUMMARY OF THE INVENTION

The present invention seeks to reduce the waste from current manufacturing methods while achieving similar or better performance than the high performance multiple piece golf club heads at a price point that is similar to conventional multiple piece golf club heads.

Thus, the present invention results in a significant reduction in finishing costs. More specifically, the finishing process for weld polishing requires expensive polishing belts. There are approximately five different belts ranging from very coarse to very fine. Each belt can usually polish around four to five golf club heads.

In the process of the present invention a crown component is bonded into the golf club head subassembly.

The resulting weight of the crown in carbon composite ranges from 5 grams to 30 grams, more preferably from 10 grams to 25 grams. The weight of the crown in the high performance multi-piece of the prior art is approximately 31 grams. By using the method of construction of the present invention, a manufacturer obtains at least an additional seven grams of discretionary weight that can be used in other sections of the golf club head to improve mass properties such as moment of inertias (Izz, Iyy and Izz) through the center of gravity of the golf club head, durability (thicker face regions or other regions open to stress during loading), and lower positioning of the center of gravity by shifting the mass of the golf club head.

The process includes bonding the crown component to the golf club head subassembly to create an unfinished fairway type golf club head. The unfinished golf club head is cleaned and finished.

This present invention is unique from other composite crown golf club heads or high performance multi-piece construction golf club heads because material is not wasted beyond what is necessary to form the golf club head. In traditional composite crown golf club heads, the whole golf club head is formed (either by casting or welding) and then an opening is cut from this whole golf club head for the composite crown. In the high performance multi-piece construction golf club heads, the crown component material is very expensive relative to conventional stamped or cast materials, and this high performance multi-piece construction golf club head crown component material needs to be chemically milled to achieve its performance. The cutting and chemical milling wastes material and adds cost to achieve performance. The method of the present invention achieves the same performance without adding additional costs.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a perspective view of an unfinished golf club head.

FIG. 2 is a side view of an unfinished golf club head.

FIG. 3 is a bottom perspective view of an unfinished golf club head.

FIG. 4 is an isolated top perspective view of an interior of a subassembly of a golf club head to illustrate the bonding flange of a face component.

FIG. 5 is an isolated front perspective view of a crown component of a golf club head illustrating the bonding flange of the crown component.

FIG. 6 is an enlarged isolated view of a crown component of FIG. 5 illustrating the bonding flange and joint for bonding with the subassembly.

FIG. 7 is a cross-sectional view of a bonding joint of a golf club head illustrating a bonding flange of the face component and the crown component.

FIG. 8 is a cross-sectional view of a bonding joint of a golf club head illustrating a bonding flange of a crown component and a sole component.

FIG. 9 is a flow chart of the method of the present invention.

### DETAILED DESCRIPTION OF THE INVENTION

The process of the present invention includes the manufacture of a cast subassembly. The cast subassembly is preferably composed of a stainless steel material. Alternatively, the subassembly is formed of a titanium alloy material. The crown component 16 is preferably formed from a carbon composite. The golf club head subassembly is polished and prepared for adhesive bonding. The composite crown is bonded to the golf club head subassembly using an adhesive. After the adhesive cures, the unfinished golf club head is cleaned and finished (typically painting).

The present invention comprises a method for forming a fairway type golf club head. The method comprises casting a golf club head subassembly from a titanium alloy material. The subassembly comprises a face component 10 and a sole component 18. The face component 10 comprises a striking plate 12 section and a return section 14. The return section has a bonding flange 11 which extends approximately 0.200 inch rearward.

The crown component 16 has a bonding flange 17 between itself and the sole 12. Because of this design feature, the compression molded manufacturing technique is a preferred manufacturing technique. Alternative forming techniques include continuous fiber laminate construction and plastic injection molding.

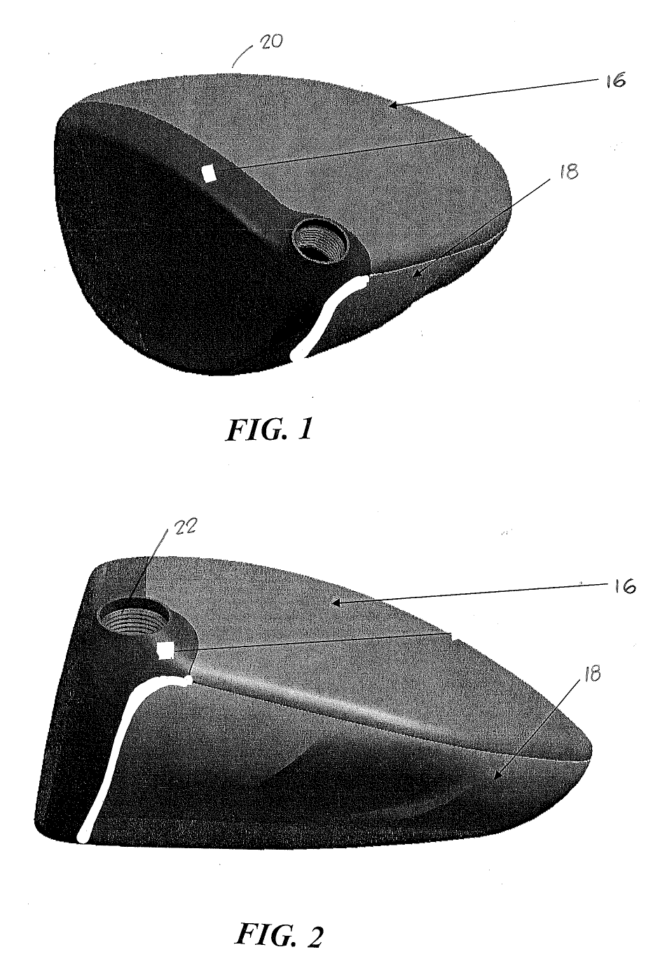

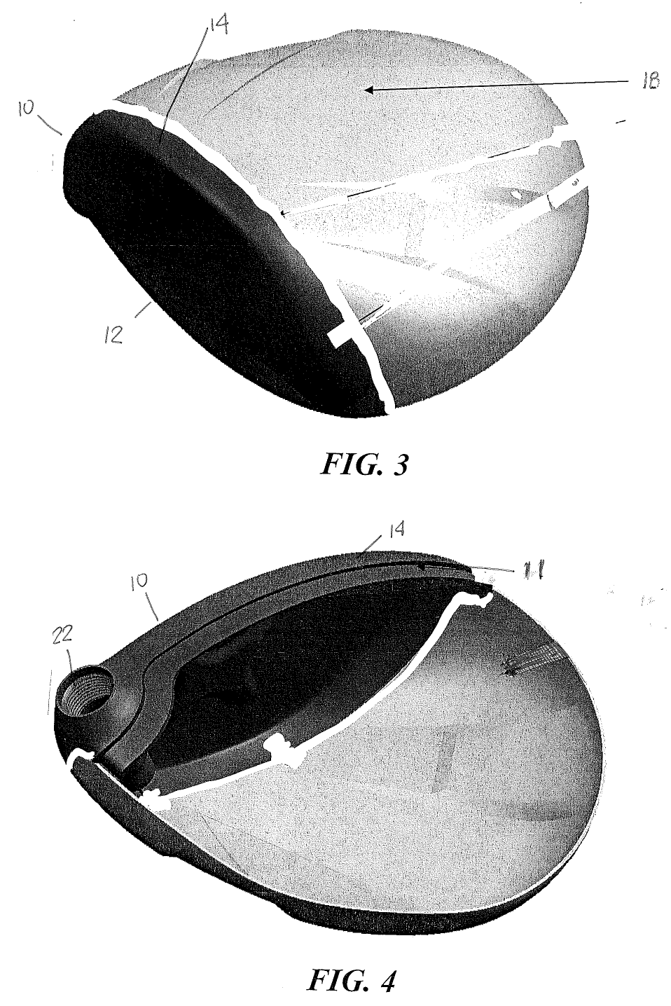

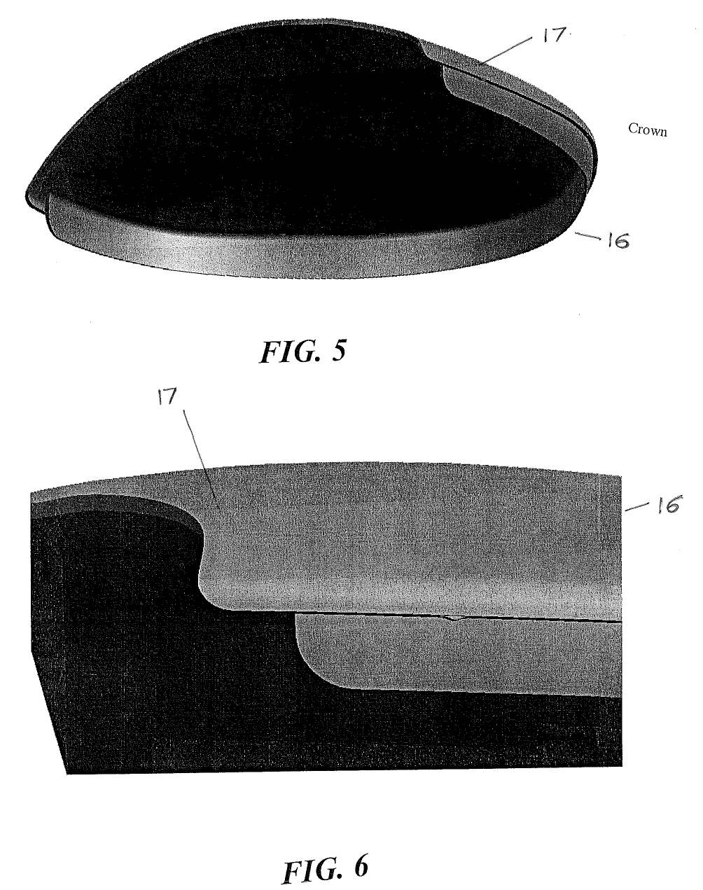

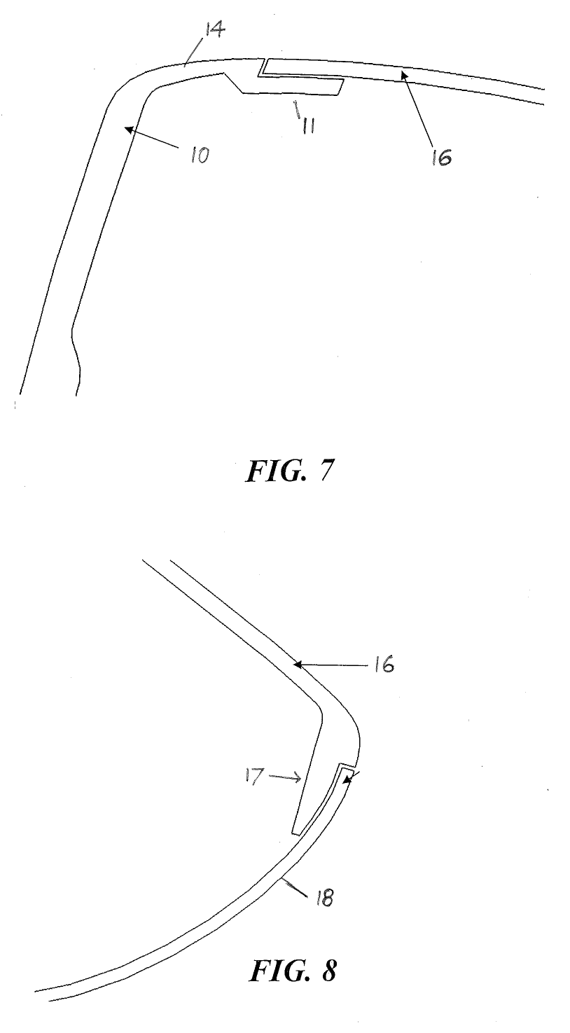

As shown in FIGS. 1-8, a fairway-type golf club head 20 is composed of a subassembly with a face component 10 with a bonding flange 11, and a crown component 16 with a bonding flange 17 in order to construct the fairway-type golf club head 20 according to a method of the present invention.

In one embodiment, the bonding flange 17 of the crown component 16 does not overlap the bonding flange 11 of the face component 10. The face component 10 may further comprise a hosel 22, which may be either interior or exterior. The golf club head 20 may further have seven grams of additional discretionary mass as compared to high performance golf club head construction. The face component 16 may also have a milled variable face thickness pattern. In another embodiment, the crown component 16 may be composed of a non-metal.

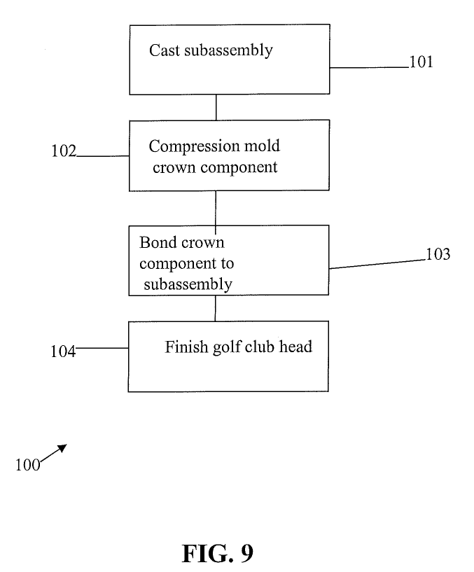

A preferred method of the present invention is illustrated in FIG. 9 and generally designated 100. At block 101, a subassembly is cast. At block 102, a crown component is compression molded from a graphite compound. At block 103, the crown component is adhesively bonded to the subassembly. At block 104, the golf club head is finished.

The present invention is directed at a golf club head that has a high coefficient of restitution thereby enabling for greater distance of a golf ball hit with the golf club head of the present invention. The coefficient of restitution (also referred to herein as “COR”) is determined by the following equation:

$$e = \frac{{v}_{2} - {v}_{1}}{{U}_{1} - {U}_{2}}$$

wherein U₁ is the club head velocity prior to impact; U₂ is the golf ball velocity prior to impact which is zero; v₁ is the club head velocity just after separation of the golf ball from the face of the club head; v₂ is the golf ball velocity just after separation of the golf ball from the face of the club head; and e is the coefficient of restitution between the golf ball and the club face.

The values of e are limited between zero and 1.0 for systems with no energy addition. The coefficient of restitution, e, for a material such as a soft clay or putty would be near zero, while for a perfectly elastic material, where no energy is lost as a result of deformation, the value of e would be 1.0. The present invention provides a club head having a coefficient of restitution ranging from 0.81 to 0.94, as measured under conventional test conditions.

The mass of the club head of the present invention ranges from 165 grams to 250 grams, preferably ranges from 175 grams to 230 grams, and most preferably from 190 grams to 205 grams. Preferably, the subassembly preferably has a mass ranging from 140 grams to 200 grams, more preferably ranging from 150 grams to 180 grams, yet more preferably from 155 grams to 166 grams, and most preferably 161 grams. The crown component has a mass preferably ranging from 4 grams to 20 grams, more preferably from 5 grams to 15 grams, and most preferably 7 grams.

The golf club head preferably has a volume that ranges from 290 cubic centimeters to 600 cubic centimeters, and more preferably ranges from 330 cubic centimeters to 510 cubic centimeters, even more preferably 350 cubic centimeters to 495 cubic centimeters, and most preferably 415 cubic centimeters or 460 cubic centimeters.

The axes of inertia are designated X, Y and Z. The X axis extends from the striking plate insert through the center of gravity, CG, and to the rear of the golf club head. The Y axis extends from the toe end of the golf club head through the center of gravity, CG, and to the heel end 66 of the golf club head. The Z axis extends from the crown section through the center of gravity, CG, and to the sole section.

As defined in Golf Club Design, Fitting, Alteration & Repair, 4^{th} Edition, by Ralph Maltby, the center of gravity, or center of mass, of the golf club head is a point inside of the club head determined by the vertical intersection of two or more points where the club head balances when suspended. A more thorough explanation of this definition of the center of gravity is provided in Golf Club Design, Fitting, Alteration & Repair.

The center of gravity and the moment of inertia of a golf club head are preferably measured using a test frame (X^{T}, Y^{T}, Z^{T}), and then transformed to a head frame (X^{H}, Y^{H}, Z^{H}). The center of gravity of a golf club head may be obtained using a center of gravity table having two weight scales thereon, as disclosed in U.S. Pat. No. 6,607,452, entitled High Moment Of Inertia Composite Golf Club, and hereby incorporated by reference in its entirety.

In general, the moment of inertia, Izz, about the Z axis for the golf club head preferably ranges from 2800 g-cm² to 5000 g-cm², preferably from 3000 g-cm² to 4500 g-cm², and most preferably from 3750 g-cm² to 4250 g-cm². The moment of inertia, Iyy, about the Y axis for the golf club head preferably ranges from 1500 g-cm² to 4000 g-cm², preferably from 2000 g-cm² to 3500 g-cm², and most preferably from 2400 g-cm² to 2900 g-cm². The moment of inertia, Ixx, about the X axis for the golf club head 40 preferably ranges from 1500 g-cm² to 4000 g-cm², preferably from 2000 g-cm² to 3500 g-cm², and most preferably from 2500 g-cm² to 3000 g-cm².

In general, the golf club head has products of inertia such as disclosed in U.S. Pat. No. 6,425,832, and is hereby incorporated by reference in its entirety. Preferably, each of the products of inertia, Ixy, Ixz and Iyz, of the golf club head 40 have an absolute value less than 100 grams-centimeter squared. Alternatively, the golf club head 40 has a at least one or two products of inertia, Ixy, Ixz and Iyz, with an absolute value less than 100 grams-centimeter squared.

The width, W, preferably ranges from 4.0 inches to 5.5 inches, and most preferably from 4.75 inches to 5.0 inches. The height, H, preferably ranges from 2.0 inches to 3.0 inches, and most preferably ranges from 2.40 inches to 2.65 inches. The length, L, preferably ranges from 3.5 inches to 4.5 inches, and most preferably from 4.0 inches to 4.25 inches. The golf club head 40 may have an aspect ratio such as disclosed in U.S. Pat. No. 6,338,683 for a Striking Plate For A Golf Club Head, assigned to Callaway Golf Company, and which pertinent parts are hereby incorporated by reference.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

We claim as our invention the following:

1. A method for forming a fairway type golf club head, the method comprising:
casting a golf club head subassembly from a titanium alloy material, the subassembly comprising a face component and a sole component, the face component comprising a striking plate section and a return section, the return section having a bonding flange of approximately 0.200 inch extending rearward;
compression molding a crown component from a graphite compound, the crown component having a bonding flange;
bonding the crown component to the golf club head subassembly using an adhesive to create an unfinished golf club head; and
finishing the unfinished golf club head to create a fairway-type golf club head.

2. The method according to claim 1 wherein the bonding flange of the crown component does not overlap the bonding flange of the face component.

3. The method according to claim 1 wherein the face component further comprises a hosel.

4. The method according to claim 3 wherein the hosel is an interior hosel.

5. The method according to claim 3 wherein the hosel is an exterior hosel.

6. The method according to claim 1 wherein the fairway-type golf club head has seven grams of additional discretionary mass as compared to high performance golf club head construction.

7. The method according to claim 1 wherein the face component has a milled variable face thickness pattern.
